(19) United States
(12) Patent Application Publication
(10) Pub. No.: US 2007/0295005 A1
(43) Pub. Date: Dec. 27, 2007

(54) Work machine hydraulic system with bypass conditioning and associated method

(75) Inventor: Steve Gary Fleischmann, Dubuque, IA (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/473,442

(22) Filed: Jun. 23, 2006

(51) Int. Cl. F16D 31/02

(52) U.S. Cl. 60/468

(57) ABSTRACT

A hydraulic system for a work machine is operative to condition hydraulic fluid supplied by a pressure source when there is no demand on the pressure source for the hydraulic fluid by a hydraulic function of the work machine.

### FIELD OF THE DISCLOSURE

The present disclosure relates to conditioning of hydraulic fluid and methods and apparatus associated therewith. cl BACKGROUND OF THE DISCLOSURE

Hydraulic systems may have a closed- or open-center directional control valves to control flow of hydraulic fluid to one or more hydraulic functions. By way of definition, a “closed-center directional control valve” is a control valve in which there is no hydraulic flow therethrough when the control valve is in its neutral position. Further by way of definition, an “open-center directional control valve” is a control valve in which there is hydraulic flow therethrough when the control valve is in its neutral position. As such, a closed-center control system is a control system that has one or more closed-center directional control valves, and, correspondingly, an open-center control system is a control system that has one or more open-center directional control valves. In a closed-center control system, when there is no demand for hydraulic fluid by a hydraulic function, the pump responds by reducing displacement to zero, whereas, in an open-center control system, the pump continues to pump hydraulic fluid even when there is no demand for hydraulic fluid by a hydraulic function, thereby introducing inefficiencies avoided by the closed-center control system.

Hydraulic systems with closed-center control systems are common in both mobile and industrial applications due to the control and efficiency benefits offered over their open-center counterparts. However, when there is no hydraulic demand in a closed-center hydraulic system using a single pump, all flow paths are blocked and, as mentioned above, the pump responds by reducing displacement to zero. While this is beneficial for system efficiency, no return flow is available for fluid conditioning. This means that during periods of system inactivity, when the hydraulic system could be taking advantage of idle time by conditioning the fluid, it is not. The result is higher average hydraulic oil temperatures and increased levels of fluid borne contaminant, which are major contributors of hydraulic component wear and reduced system life.

To address this problem, there are hydraulic systems which have a main working circuit and an additional supplemental circuit. As indicated above, the main working circuit has a pump that advances hydraulic fluid through a closed-center control circuit to one or more hydraulic functions. The supplemental circuit has an additional pump which advances hydraulic fluid from the main hydraulic fluid reservoir through a filtration and cooling system to condition the hydraulic fluid continuously. As such, this supplemental circuit is sometimes called an offline circuit or kidney loop filtration circuit. However, inclusion of this additional supplemental circuit is not always feasible due to physical space constraints or cost considerations.

### SUMMARY OF THE DISCLOSURE

According to the present disclosure, there is provided a hydraulic system for use in a variety of applications including, but not limited to, work machines such as, for example, mobile and industrial work machines. The hydraulic system comprises a pressure source (e.g., pump) for supplying hydraulic fluid, at least one hydraulic function, a closed-center directional control valve for controlling flow of hydraulic fluid from the pressure source to the at least one hydraulic function, a fluid-conditioning circuit for conditioning hydraulic fluid (e.g., filtering and/or cooling), and a bypass system.

The bypass system detects if there is a demand on the pressure source for hydraulic fluid by any of the at least one hydraulic function and, if there is no such demand, directs hydraulic fluid advanced by the pressure source away from the closed-center directional control valve to the fluid-conditioning circuit via a flow path not in communication with any hydraulic function of the work machine. The hydraulic system thus takes advantage of periods of hydraulic function inactivity, or otherwise reduced activity, by conditioning the fluid for further use during such periods. An associated method is disclosed.

In some embodiments, the bypass system has a normally-closed electro-hydraulic valve under the control of an electronic controller. The electronic controller processes one or more signals inputted into the controller to detect the presence of any demand for hydraulic fluid, and, if there is no demand, signals the valve to open the flow path between the pressure source and the fluid-conditioning circuit to begin fluid conditioning.

The electronic controller may monitor various signals to detect whether to open the flow path. For example, the electronic controller may monitor signals representative of hydraulic oil temperature, outlet pressure of the pressure source, and/or engine load of an engine of the work machine, to name just a few.

In other embodiments, the bypass system has a pilot-operated valve spring-biased toward an open position so as normally to open the flow path between the pressure source and the fluid-conditioning circuit. Load sense pressure may be connected to the pilot section of the valve such that, when hydraulic fluid is demanded for operation of one of the hydraulic functions, load sense pressure increases, closing the valve and thus the flow path between the pressure source and the fluid-conditioning circuit.

As alluded to above, the conditioning circuit may be used to filter the hydraulic fluid. In such a case, the bypass flow provided by the bypass system is potentially much more effective at promoting filtration of the hydraulic fluid at the filter than main function return flow. This is because filters are more efficient when supplied with a steady, low flow input similar to the bypass flow but in contrast to the dynamic, high flow surges from the main circuit.

The above and other features will become apparent from the following description and the attached drawings.

### BRIEF DESCRIPTION OF THE DRAWINGS

The detailed description of the drawings refers to the accompanying figures in which:

FIG. 1 is a simplified diagrammatic view of a hydraulic circuit for use with a work machine;

FIG. 2 is a simplified diagrammatic view showing incorporation of the hydraulic circuit into backhoe loader hydraulic circuitry;

FIG. 3 is a combination of FIGS. 3a and 3b which are left and right portions, respectively, of a backhoe loader hydraulic schematic; and

FIG. 4 is a simplified diagrammatic view of an alternative valve.

### DETAILED DESCRIPTION OF THE DRAWINGS

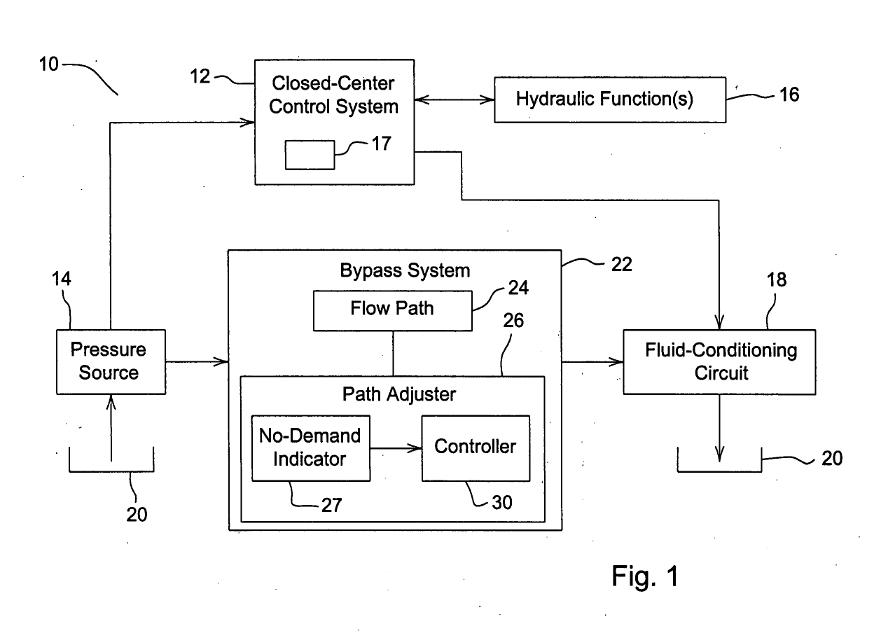

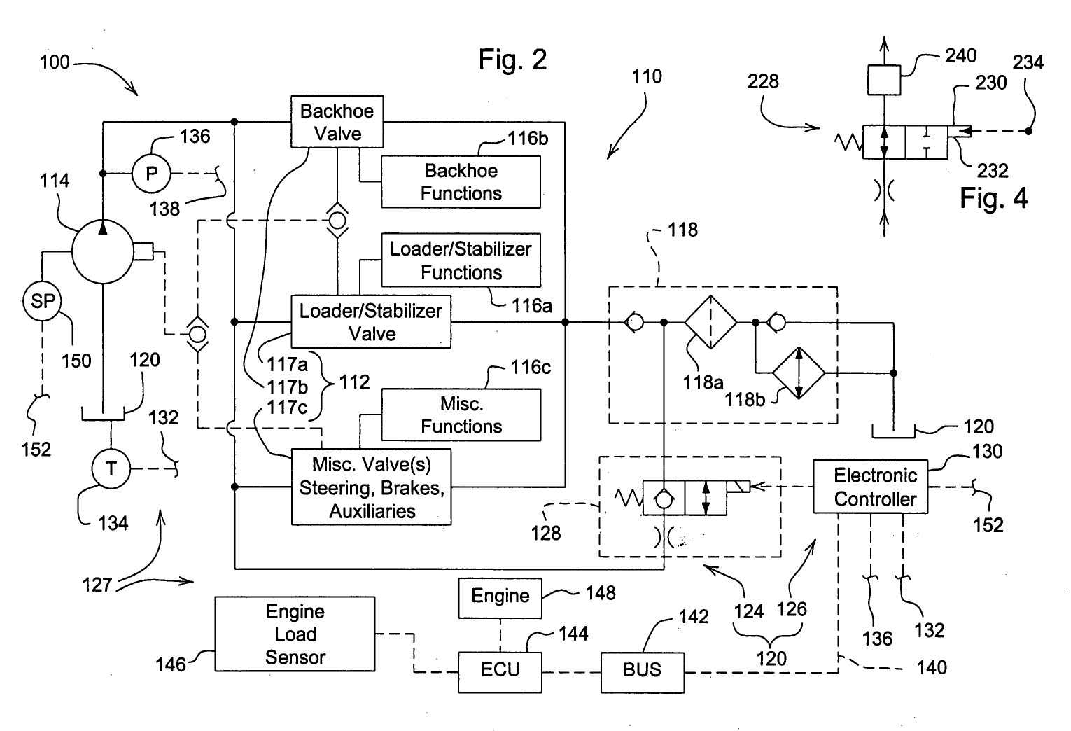

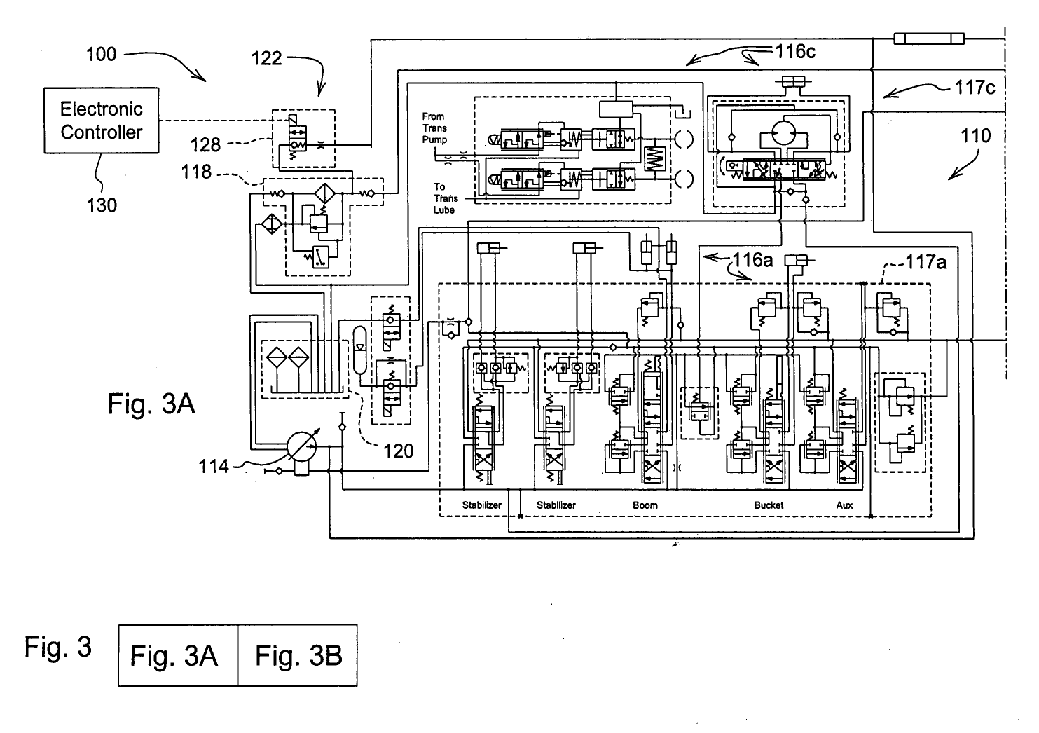

Referring to FIG. 1, there is shown a hydraulic system 10 for use with a variety of applications including, but not limited to, work machines such as, for example, mobile and industrial work machines. The hydraulic system 10 may be embodied as the hydraulic system 110 configured exemplarily for use with a backhoe loader 100, as shown in FIGS. 2, 3A, and 3B.

The hydraulic system 10 has a closed-center control system 12 disposed fluidly between a pressure source 14 and a number of hydraulic function(s) 16 of the work machine to control flow of hydraulic fluid supplied by the pressure source 14 to the respective hydraulic function 16 in response to a demand on the pressure source 14 for hydraulic fluid by the function 16. When there is no demand for hydraulic fluid, each closed-center directional control valve 17 of the control system 12 (the control system 12 may have one or more such control valves 17) assumes its neutral position blocking flow of hydraulic fluid therethrough. When there is a demand for hydraulic fluid by a function 16, the respective control valve 17 opens accordingly to allow flow therethrough to the function 16 so as to satisfy its demand. Afterwards, the hydraulic fluid is routed to a fluid-conditioning circuit 18 for conditioning thereby (e.g., filtering and/or cooling) and then on back to a hydraulic fluid reservoir 20 from which the pressure source 14 draws hydraulic fluid.

A bypass system 22 of the hydraulic system 10 is configured to cause hydraulic fluid to bypass the closed-center control system 12 so as to direct the hydraulic fluid to the fluid-conditioning circuit 18 for conditioning thereby during periods when at least one control valve 17 is in its neutral position due to no demand for hydraulic fluid by any of hydraulic function(s) 16 associated therewith. All control valves 17 of the control system 12 will be bypassed during periods of inactivity of all functions 16. The bypass system 22 detects if there is a demand on the pressure source 14 for hydraulic fluid by the hydraulic function(s) 16 associated with a particular control valve 17 and, if there is no such demand, directs hydraulic fluid advanced by the pressure source 14 away from that control valve 17 to the fluid-conditioning circuit 18 via a flow path 24 which is not in communication with any function 16 of the work machine. In cases where the bypass system 22 detects no demand on the pressure source 14 for hydraulic fluid by any hydraulic function 16 of the work machine, the system 22 directs hydraulic fluid advanced by the pressure source 14 away from each control valve 17 to the fluid-conditioning circuit 18 via the flow path 24.

The hydraulic system 10 is thus designed to take advantage of periods of hydraulic function inactivity, or otherwise reduced activity, by conditioning the fluid for further use during such periods. The hydraulic system 10 is designed to do so regardless of engine speed. No additional pump is needed to advance the hydraulic fluid to the fluid-conditioning circuit 18. Indeed, exemplarily, the pressure source 14 is configured as a pump (e.g., a variable displacement pump) and, moreover, it is the only pump in the hydraulic system 10. The bypass system 22 thus provides means for detecting if there is a demand on the pump for hydraulic fluid by any of the hydraulic functions 16 of the work machine and, if there is no such demand, directing hydraulic fluid advanced by the pump away from each closed-center directional control valve 17 to the fluid-conditioning 18 circuit via a flow path 24 not in communication with any of the hydraulic functions 16 of the work machine.

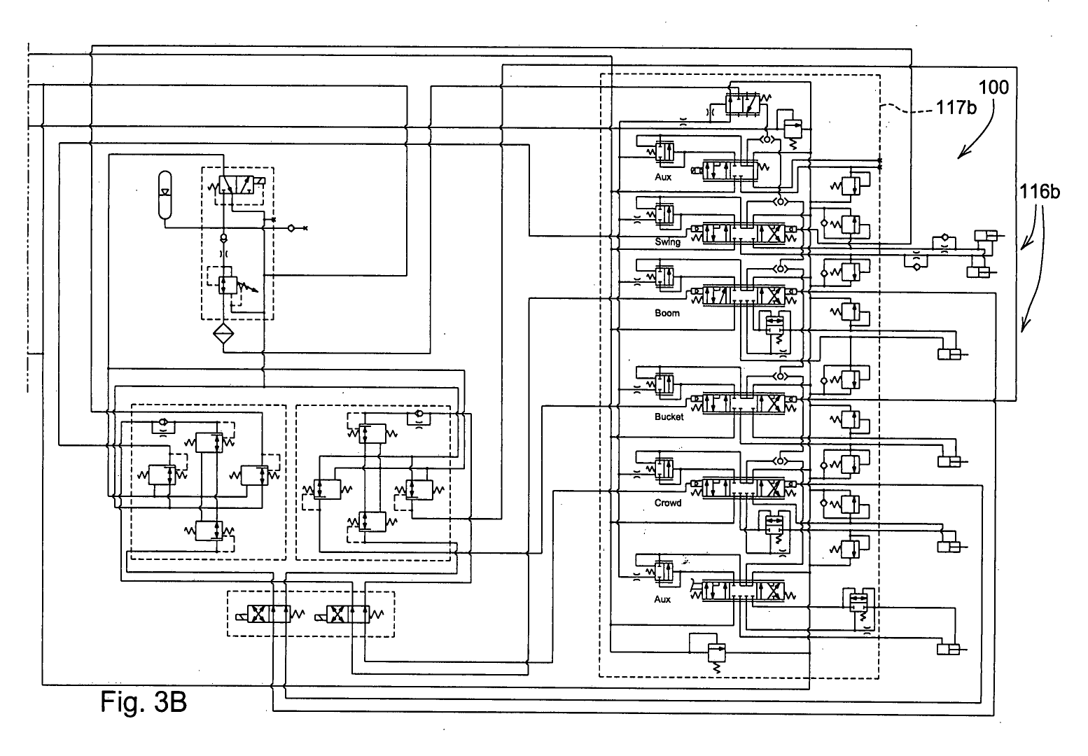

Generally speaking, the bypass system 22 includes an adjustable flow path 24 and a path adjuster 26. The flow path 24 is adjustable in the sense that its restriction to flow of hydraulic fluid can be varied by the path adjuster 26. Exemplarily, the flow path 24 is provided by a valve mounted in a flow passageway extending between a point in communication with outlet pressure of the pressure source 14 and the fluid-conditioning circuit 18. The valve may be an electro-hydraulic valve as in the embodiments of FIGS. 2 to 3B or may be a pilot-operated valve as in the embodiment of FIG. 4.

The path adjuster 26 may take a variety of forms. In each case, the path adjuster 26 may include a no-demand indicator 27 for indicating when there is no demand from the function(s) 16 and a controller 30 for receiving signal(s) (e.g., electrical, fluid) from the no-demand indicator 28 to control adjustment of the fluid restriction characteristic of the flow path 24. For example, in the case where the valve is electro-hydraulic, the path adjuster 26 may include an electronic controller which receives a number of input signals from a number of sensors acting as the no-demand indicator and processes those signals to determine whether there is a demand for hydraulic fluid and, if not, to control a solenoid of the electro-hydraulic valve to open the valve to allow flow of hydraulic fluid to the fluid-conditioning circuit 18. Such an example is illustrated in FIGS. 2 to 3B. In the pilot-operated example, there may be a no-demand indicator in the form of a pilot circuit tapped into the pump outlet or load sense pressure to feed that pressure to a pilot section of the valve to close the valve when there is an increase in pump outlet pressure due to a demand for hydraulic fluid, the pilot section acting as the “controller” for controlling opening and closing of the valve. These examples are discussed more fully below.

Referring to FIGS. 2, 3A, and 3B, the hydraulic circuit 10 may be embodied as the hydraulic circuit 110 incorporated into a backhoe loader 100. In such an example, the hydraulic circuit 110 has a single variable displacement pump 114 which draws hydraulic fluid from the hydraulic fluid reservoir 120 to supply the hydraulic fluid to a closed-center control system 112. The control system 112 includes a loader/stabilizer closed-center directional control valve 117a for control of various loader/stabilizer functions 116a, a backhoe closed-center directional control valve 117b for control of various backhoe functions 116b, and other miscellaneous closed-center directional control valves 117c for control of various functions 116c such as vehicle steering, brakes, and auxiliary systems.

A fluid-conditioning circuit 118 is disposed fluidly between the control system 112 and the reservoir 120 in a return line to condition fluid before return to the reservoir 120. Exemplarily, the circuit 118 has a filter 118a for filtering contaminants from the hydraulic fluid and a cooler 118b for cooling the hydraulic fluid.

Illustratively, the bypass system 22 is embodied as the bypass system 122. The system 122 includes an adjustable flow path 124 and path adjuster 126 for adjusting the flow-restriction of the flow path 124. In the flow path 124, there is an electro-hydraulic valve 128 under the control of an electronic controller 130. Exemplarily, the valve 128 is a two-position, two-way, normally closed, solenoid-operated valve.

The controller 130 monitors the output of a no-demand indicator 127. Such output may include a number of signals inputted into the controller 130 from a number of sensors. Based on such input signals received by the controller 130, the controller 130 makes the determination whether there is a demand for hydraulic fluid by a function 116, and, if not, signals the valve 128 to open to establish the bypass flow of hydraulic fluid to the conditioning circuit 118. Exemplarily, if the conditioning is to include cooling of the hydraulic fluid, one of the signals may be a temperature signal 132 received from a temperature sensor 134 positioned to sense the temperature of hydraulic fluid in the reservoir 120. The controller 130 may use the temperature signal 132 to determine whether the hydraulic fluid has at least reached a minimum operational temperature below which cooling is not needed. Further, the controller 130 may use the temperature signal 132 to determine when the fluid has been cooled to an acceptable temperature at which point further cooling may be ceased.

The controller 130 may receive a pressure signal 136 from a pressure sensor 138 positioned to sense an outlet pressure of the pump 114 or load sense pressure. If the pump 114 is at a predetermined standby pressure indicative of no demand, the controller 130 may determine from the pressure signal 136 that there is no demand on the pump 114 and energize the solenoid of the valve 128 to open the valve 128. This newly opened flow path will cause a slight drop in outlet pressure at the pump 114. The pump 114 will automatically respond by increasing displacement to satisfy this demand until differential pressure for a load-sensing pump (as in the illustrated example) or outlet pressure for a pressure-compensated pump returns to the original value. However, since a pressure-compensated pump generally would not indicate hydraulic demand by outlet pressure until demand exceeds full displacement, engine load or displacement of the pump 114 may provide more useful inputs to the controller 130 as indicators of a no-demand situation.

The controller 130 may receive an engine load signal 140 broadcast on a communication bus 142 of the work machine 100 by an engine control unit 144. The ECU 144 generates the message in response to engine load information received from an engine load sensor 146 that senses loading on an engine 148 of the work machine 100. The controller 130 determines whether the engine 148 has been unloaded (e.g., at a low engine load factor) for a predetermined period of time and, if so, determines that there is no demand in which case bypass conditioning may be initiated. The engine load factor would be particularly useful at providing an indication of a no-demand situation regardless of engine speed.

The controller 130 may use any one or more of the hydraulic fluid temperature, pump outlet pressure, and engine load to detect if there is no demand. As such, the temperature sensor 134, the pressure sensor 138, and the engine load sensor 146, or any combination thereof may act as the no-demand indicator 127. Preferably, the pump outlet pressure signal 136 will be provided to the controller 130 and the engine load signal 140 will act as a redundant check. In such a case, the controller 130 detects that there is no demand when it determines that the hydraulic fluid temperature exceeds a predetermined temperature, the outlet pressure of the pump is at a predetermined standby pressure (e.g., pump is at standby position), and the engine 148 has been unloaded for a predetermined period of time. Further, the controller 130 de-energizes the solenoid when hydraulic oil temperature falls below the predetermined temperature (or some other temperature), the pump outlet pressure changes from the predetermined standby pressure (e.g., displacement position of pump beyond predetermined position), or the engine is loaded.

The pressure signal 136 and the engine load signal 140 may be used alone or together, with or without the temperature signal 132. In addition, the temperature signal 132 may be used alone, or, in cases where, for example, conditioning is not to include cooling, the temperature signal 132 may be omitted altogether.

Further, as alluded to above, a displacement sensor 150 may be included in the no-demand indicator 127. The displacement sensor 150 senses fluid displacement of the pump 114 and provides such information to the controller 130 via a displacement signal 152. The displacement sensor 150 may provide the sole no-demand input or act in concert with any of the aforementioned sensors or other sensor(s). Inclusion of the displacement sensor 150 in the no-demand indicator 127 may be useful with load-sensing or pressure-compensated pumps. Exemplarily, the displacement sensor 150 may be a swashplate position sensor that senses the position of the swashplate of a piston-type variable displacement hydraulic pump or a cam position sensor that senses the position of the movable cam of a variable displacement vane pump.

Referring to FIG. 4, there is shown a pilot-operated valve 228 which, alternatively, may be used in the bypass system 120 in place of the electro-hydraulic configuration. The valve 228 is spring-biased toward an open position so as normally to open the flow path 124 between the pump 114 and the fluid-conditioning circuit 118. A pilot circuit 232 is fluidly coupled to a pump outlet port 234 of the pump 114 and a pilot section 230 of the valve 228. Load sense pressure may be connected to the pilot section 230 via the pilot circuit 232 such that, when hydraulic fluid is demanded for operation of one of the hydraulic functions 116, load sense pressure increases, closing the valve 228 and thus the flow path 124 between the pump 114 and the fluid-conditioning circuit 118. In such a case, the pilot circuit 232 acts as the no-demand indicator and the pilot section 230 acts as the controller.

A thermostat 240 may be disposed downstream from the valve 228 to control bypass flow in response to temperature. In such a case, the thermostat 240 acts in conjunction with the pilot section 230 to provide the controller.

While the disclosure has been illustrated and described in detail in the drawings and foregoing description, such an illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

1. A work machine, comprising:
a hydraulic fluid reservoir,
a plurality of closed-center directional control valves,
at least one hydraulic function associated with each closed-center directional control valve,
a variable displacement pump for advancing hydraulic fluid from the fluid reservoir through each closed-center directional control valve to the at least one hydraulic function associated therewith,
a fluid-conditioning circuit for conditioning hydraulic fluid, the fluid-conditioning circuit disposed fluidly between the plurality of closed-center directional control valves and the hydraulic fluid reservoir, and
means for detecting if there is a demand on the pump for hydraulic fluid by any of the hydraulic functions and, if there is no such demand, directing hydraulic fluid advanced by the pump away from the closed-center directional control valves to the fluid-conditioning circuit via a flow path not in communication with any of the hydraulic functions.

2. The work machine of claim 1, wherein the flow path has an adjustable flow-restriction, and the means comprises a path adjuster for adjusting the flow-restriction according to the outcome of detecting if there is a demand.

3. The work machine of claim 1, wherein the flow path comprises an electro-hydraulic valve, and the means comprises an electronic controller electrically coupled to the electro-hydraulic valve.

4. The work machine of claim 1, wherein the flow path comprises a pilot-operated valve, and the means comprises a pilot circuit fluidly coupled to a pump outlet port and the valve.

5. The work machine of claim 1, wherein the means comprises a pressure sensor disposed to sense outlet pressure of the pump, an engine load sensor, a hydraulic fluid temperature sensor, or a displacement sensor for sensing fluid displacement of the pump.

6. A hydraulic system for a work machine, comprising:
a pressure source for supplying hydraulic fluid,
at least one hydraulic function,
a closed-center directional control valve for controlling flow of hydraulic fluid from the pressure source to the at least one hydraulic function,
a fluid-conditioning circuit, and
a bypass system that detects if there is a demand on the pressure source for hydraulic fluid by any of the at least one hydraulic function and, if there is no such demand, directs hydraulic fluid advanced by the pressure source away from the closed-center directional control valve to the fluid-conditioning circuit via a flow path not in communication with any hydraulic function of the work machine.

7. The hydraulic system of claim 6, wherein the bypass system comprises a valve fluidly coupled to the pressure source and the fluid-conditioning circuit.

8. The hydraulic system of claim 7, wherein the valve is normally closed, and the bypass system comprises an electronic controller electrically coupled to the valve to open the valve.

9. The hydraulic system of claim 7, wherein the valve is a normally open, pilot-operated valve.

10. The hydraulic system of claim 7, wherein the bypass system comprises a pressure sensor fluidly coupled to the outlet of the pressure source and an electronic controller electrically coupled to the pressure sensor and the valve.

11. The hydraulic system of claim 7, wherein the bypass system comprises an electronic controller electrically coupled to the valve and responsive to an engine load signal to detect if the demand is present.

12. The hydraulic system of claim 7, wherein the pressure source comprises a pump, and the bypass system comprises a displacement sensor for sensing fluid displacement of the pump and an electronic controller electrically coupled to the displacement sensor and the valve.

13. The hydraulic system of claim 7, wherein the bypass system comprises a no-demand indicator and a controller that operates the valve in response to at least one signal from the no-demand indicator.

14. The hydraulic system of claim 6, wherein the bypass system comprises a temperature sensor.

15. The hydraulic system of claim 6, wherein the closed-center directional control valve and the bypass system are flow-parallel to one another.

16. A method of operating a work machine, the method comprising:
detecting if there is a demand on a pump for hydraulic fluid by any hydraulic function of the work machine, a closed-center control system disposed fluidly between the pump and each hydraulic function of the work machine, and
if there is no such demand, directing hydraulic fluid advanced by the pump away from the closed-center control system to a fluid-conditioning circuit via a flow path not in communication with any hydraulic function of the work machine.

17. The method of claim 16, wherein the detecting comprises sensing an outlet pressure of the pump.

18. The method of claim 16, wherein the detecting comprises sensing a load on an engine.

19. The method of claim 16, wherein the detecting comprises determining that hydraulic fluid temperature exceeds a predetermined temperature, outlet pressure of the pump is at a predetermined standby pressure, and an engine of the work machine has been unloaded for a predetermined period of time.

20. The method of claim 16, wherein the directing comprises operating a valve disposed fluidly between the pump and the fluid-conditioning circuit.
